(19) United States
(12) Patent Application Publication
(10) Pub. No.: US 2016/0259641 A1
(43) Pub. Date: Sep. 8, 2016

(54) TAGGING A PROGRAM CODE PORTION

(71) Applicant: HEWLETT PACKARD ENTERPRISE DEVELOPMENT LP, Houston, TX (US)

(72) Inventors: Guy Wiener, Haifa (IL); Omer Barkol, Haifa (IL)

(21) Appl. No.: 15/033,148

(22) PCT Filed: Dec. 16, 2013
(86) PCT No.: PCT/US2013/075288

§ 371 Date: Apr. 29, 2016

(51) Int. Cl. G06F 9/44

(52) U.S. Cl. CPC G06F 8/73; G06F 8/36

(57) ABSTRACT

A data structure is based on examples that include respective program code portions associated with corresponding tags that indicate content of the respective program code portions. A tagger determines at least one tag to associate with a first program code portion based on the data structure. An updated version of the data structure is received, The tagger, which remains unmodified, determines at least one tag to associate with a second program code portion based on the updated version of the data structure.

### BACKGROUND

Program code development involves producing program code portions that can be part of one or multiple program files. The program code portions can be created from scratch, or alternatively, previously created program code portions can be reused, possibly with modifications. To be able to reuse previously created program code portions, a developer can perform a search for such previously created program code portions that are relevant to the developer's current work.

### BRIEF DESCRIPTION OF THE DRAWINGS

Some implementations are described with respect to the following figures.

FIG. 1 is a schematic diagram of a tagging arrangement according to some implementations.

FIGS. 2 and 3 are flow diagrams of tagging processes for tagging program code portions according to various implementations.

FIG. 4 is a block diagram of an example computer system that includes an index creator and a tagger according to some implementations.

### DETAILED DESCRIPTION

A program code can refer to computer-readable instructions for performing specific tasks. The program code can be in the form of a source code, which includes code according to a specific programming language. The source code can be transformed into executable code for execution by a computer,

A program code portion can refer to a subset that is less than an entirety of a program file that contains the program code. Alternatively, a program code portion can refer to an entirety of the program file. A program code portion can also be referred to as a program code snippet.

A program code portion can be labeled with one or multiple tags that indicate content of the program code portion. As examples, tags can include the following types of information associated with content of the program code portion: information identifying the technology of the program code portion, information identifying the language of the program code portion, information identifying one or multiple topics associated with the program code portion, information identifying one or multiple skills (of personnel) associated with the program code portion, and so forth.

The technology of a program code portion can specify an environment that the program code portion is designed to work in. For example, the environment can be an environment of a specific operating system, such as WINDOWS®, Linux, Unix, and so forth. Alternatively, the environment can be a web-based environment, a database environment, and so forth.

The language of a program code portion specifies the syntax and the semantics of instructions that make up the program code portion. The syntax defines the form of the instructions, while the semantics assign meanings to terms, operators, and other elements of the instructions.

The tags associated with a program code portion can be useful for various purposes, such as enhancing program code search (to find a program code portion that is relevant to current work of a program developer), to summarize a lengthy program code portion, to assist a developer in understanding the program code portion, and so forth.

Traditional program tagging mechanisms may lack flexibility in tagging program code. Some traditional tagging mechanisms employ program analysis of a program code before tagging can be performed of the program code. The program analysis involves first parsing the program code according to a specific program language syntax; as a result, such traditional program tagging mechanisms cannot be applied to tag program codes according to a language that the program tagging mechanisms are not designed for (or trained for). Also, traditional program tagging mechanisms have to be applied for a complete program module that is to defined by appropriate semantic definitions.

In accordance with some implementations, a tagger is provided that performs automatic tagging of a program code portion, where the tagger can be used for program code portions of any programming language or technology, and to identify tags from a collection of tags that does not have to be predefined. The tagger does not assume any specific programming language or technology of the program code portion. The tagger can be used for tagging program code portions of different programming languages without having to modify the tagger, and without having to re-train the tagger. This enhances flexibility over other program tagging mechanisms that are designed to work with specific programming languages or technologies (and thus assume specific programming language syntax and semantics) such other program tagging mechanisms would not be useable to tag program codes of other programming languages or technologies without modification or retraining of the program tagging mechanisms.

The tagger according to some implementations can also be applied to tag any arbitrary portion of a program code. An “arbitrary” portion of a program code refers to any portion of the program code that is found within the program code. The program code portion that is tagged does not have to be a semantically defined module, according to specific semantic definitions of a respective programming language. For example, certain programming languages specify that a semantically defined module is defined between an opening brace {and a closing brace}. Alternatively, the semantically defined module is included within a single

Since the tagger does not assume any specific programming language or technology, the tagger can be used for tagging program code portions according to new programming languages or technologies.

By being able to tag arbitrary program code portion, regardless of the programming language or technology of the program code portion, tagging of a hybrid collection of program codes is possible, where the program code portions in the hybrid collection can be according to different programming languages or technologies.

The tagger according to some implementations also does not assume a predefined collection of tags. Having to specify a predefined collection of tags for a program tagging mechanism reduces flexibility in the use of the program tagging mechanism. The program tagging mechanism would not be able to assign a new tag (that is not part of the predefined collection of tags) to a program code, unless the program tagging mechanism is modified or re-trained. The tagger in a accordance with some implementations is able to assign new tags to program code portions, which increases flexibility and ease of use of the tagger.

The tagging performed by the tagger according to some implementations is based on a data structure that is created based on examples that include respective program code portions associated with corresponding tags that indicate content of the respective program code portions (e.g. the programming language of a program code portion, the technology of the program code portion, topic(s) of a program code portion, skill(s) associated with a program code portions, etc.). As noted above, the tagger is able to support new programming languages and/or new tags without having to modify or retrain the tagger. Rather, to support tagging for a new programming language and/or for a new tag, a collection of examples that include respective program code portions associated with corresponding tags can be updated by simply adding one or multiple further examples relating to the new programming language and/or new tag. In this manner, even though the collection of examples is modified, the tagger remains unmodified, and can continue to be used for tagging additional program code portions.

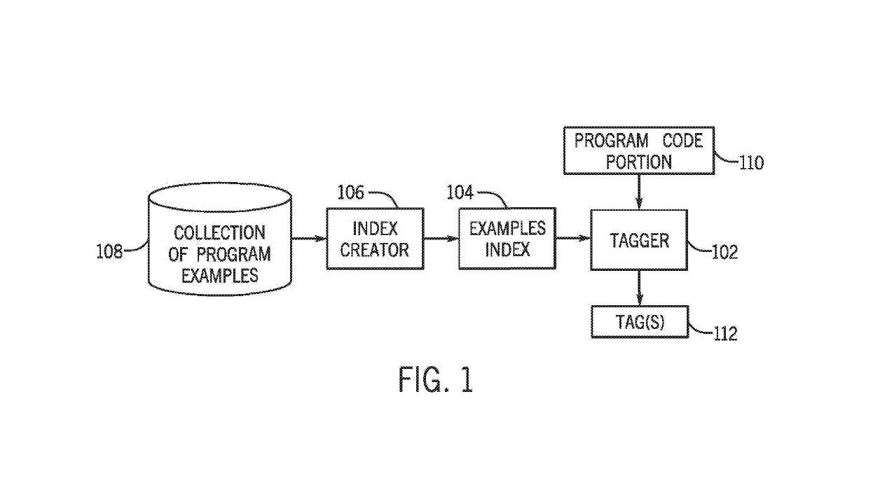

FIG. 1 is a schematic diagram of an example arrangement that includes a tagger 102 according to some implementations. The tagger 102 receives as input an examples index 104, which is created by an index creator 106 that processes a collection of program examples 108. The program examples 108 include respective program code portions and associated tags. A program code portion in a given program example can be associated with one or multiple tags, which was previously assigned, either by a human or a machine (e.g. the tagger 102), or both.

The index creator 106 parses the program examples in the collection 108. The parsing can include removing of non-text elements from each program example. A non-text element of a program example can include any of the following: an operator, a bracket, or any other element of the program code portion that is not text. Note that the parsing does not assume any specific programming language or technology; the parsing distinguishes between text and non-text elements.

The index creator 106 can also rewrite text in a program example into words according to specified coding conventions. For example, text such as “findNextElement,” which is according to the camel-hump convention, can be rewritten into the following words (which make up a token): “Find next element.” Similarly, the text “find_next_Element” can also be rewritten into the foregoing token. Rewriting text in different forms into common tokens (each token including one or multiple words) allows for better accuracy in comparing the program examples to program code portions to be tagged, as discussed further below.

The index creator 106 may also perform other pre-processing of the program examples. For example, the index creator 106 may remove redundant text in each program example, Removing redundant text helps to provide more compact program examples so that subsequent tagging can be performed more efficiently and accurately.

The examples index 104 is an index that associates sets of tokens (words produced by the index creator 106) with respective one or multiple tags. For example, the examples index 104 can include multiple entries, where each entry contains a respective set of tokens, and associated one or multiple tags (or pointers or references to such one or multiple tags). The pointers or references specify locations where the respective tags can be retrieved. Note that in some cases, a set of tokens of an entry in the index 104 may include just one token.

The tagger 102 also receives a program code portion 110 that is to be tagged. The program code portion 110 is compared to the examples index 104 by the tagger 102, which produces one or multiple tags 112 for the program code portion 110.

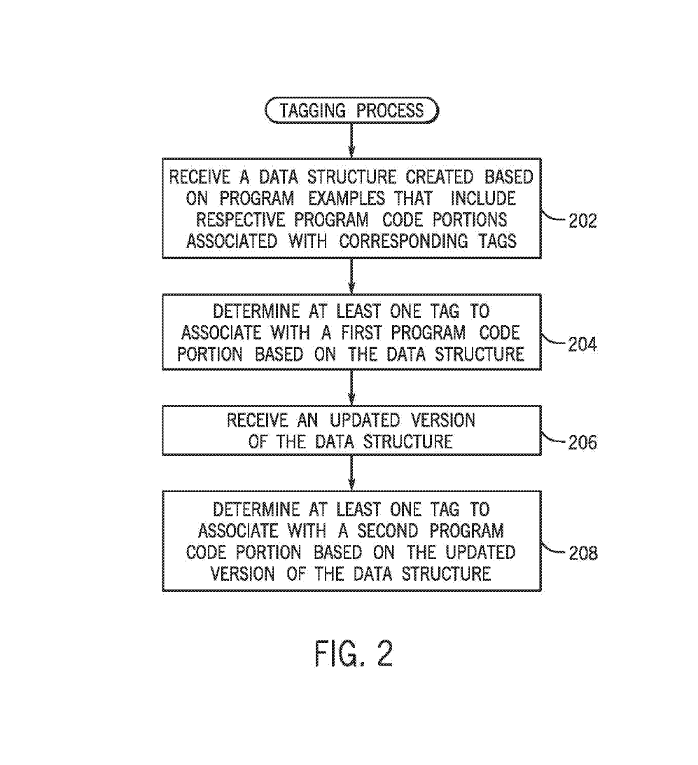

FIG. 2 is a flow diagram of a tagging process according to some implementations. The process of FIG. 2 can be performed by the tagger 102, according to some implementations. The tagger 102 receives (at 202) a data structure (e.g., the examples index 104 of FIG. 1) created based on program examples that include respective program code portions associated with corresponding tags.

The tagger 102 determines (at 204) at least one tag to associate with a first program code portion based on the data structure.

At a later point in time, the tagger 102 receives (at 206) an updated version of the data structure, which may be updated due to addition of one or multiple program examples corresponding to a new programming language, a new technology, and/or a new tag not represented by the data structure received at 202.

The tagger 102 remains unmodified even though the updated version of the data structure is received. The un-modified tagger 102 determines (at 208) at least one tag to associate with a second program code portion based on the updated version of the data structure.

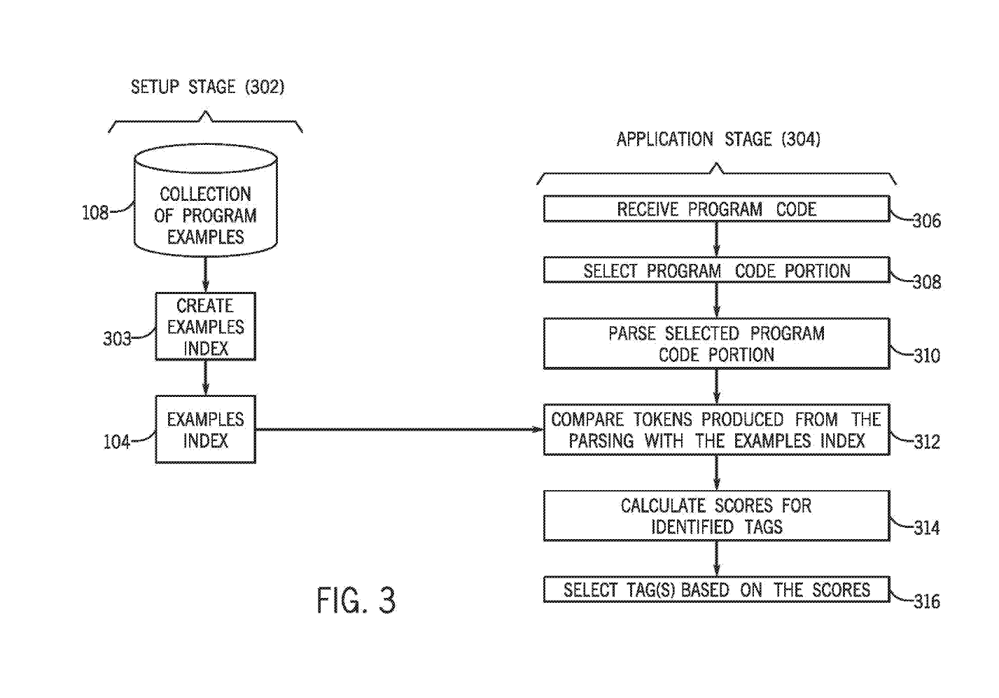

FIG. 3 is a flow diagram of a process according to further implementations. The process of FIG. 3 includes a setup stage 302 and an application stage 304. The setup stage 302 is used for creating (at 303) the examples index 104, such as by the index creator 106 based on the collection of program examples 108.

The application stage 304 receives (at 306) a program code, which can be a program file (or multiple program files). A portion of the received program code is selected (at 308), where the selected portion can be less than the entirety of the received program code, or the selected portion can be the entirety of the received program code. The selection of the program code portion can be a manual selection (made by a human) or an automatic selection (made by the tagger 102 or some other automated entity based on one or multiple selection criteria). In other implementations, other techniques can be used for providing a portion of the received program code as input to the tagger 102. In further implementations, the program code to be tagged is not a part of any program file. For example, the program code can, for example, be attached a requirements document, be part of an online programming manual, be an answer to a question in an interview, and so forth.

The selected program code portion is then parsed (at 310), which can include removing non-text elements of the selected program code portion, and extracting text elements (elements of the program code portion that contains text and is without non-text elements) from the selected program code portions. The parsing can also rewrite text of the selected program code portion into one or multiple sets of tokens. Note that the parsing does not assume any specific programming language of the selected program code portion.

The one or multiple sets of tokens are then compared (at 312) by the tagger 102 to elements (one or multiple sets of tokens) of the program examples in the examples index 104. Based on the comparing, the tagger 102 calculates (at 314) scores for respective tags identified by the comparing. Using the scores, one or multiple tags can be selected (at 316), such as the N tags having the highest scores (where N can be greater than or equal to one).

The tasks 310, 312, and 314 can be performed by the tagger 102. The tag selection performed at 316 can also be performed by the tagger 102, or alternatively, can be performed by a user or an application or another entity. An application can refer to machine-readable instructions that can receive the tags and respective scores from the tagger 102, and that can use these scores to select a subset of the tags.

The comparing performed at 312 can use a similarity function, such as a cosine document similarity function. In other examples, other types of similarity functions can be used.

To find a set of similar program examples (that are similar to a given program code portion that is to be tagged), the similarity function can use a metric that measures how similar two text portions are (in this case, a “text portion” refers to tokens parsed from a program code portion in a program example and tokens parsed from the given program code portion to be tagged). If a cosine document similarity function is used, then the metric that measures similarity of text portions is a cosine document similarity metric.

Once a set of the top K (K≧1) most similar program examples from the examples index 104 is found by the cosine document similarity function (or some other similarity function), the tagger 102 assigns a score to each one of the tags associated with the top K most similar program examples. In some implementations, a score for a tag can be calculated as follows. Note that the same tag may be associated with multiple program examples. For example, program example A is labeled with tags p and q, and program example B is labeled with tags p and r—in this case, the set of tags include p, q and r, where p repeats both program examples A and B.

For each tag, the tagger can sum (or perform another aggregate such as average, identify a maximum or minimum, etc.) the similarity scores of all the examples in the set of top K examples that are labeled with this tag. In the foregoing case, for tag p, the similarity scores of both program examples A and B are summed. However, the score for tag q is the similarity score of program example A, and the score for tag r is the similarity score of program example B.

Next, the maximal score for the set of tags is determined. The maximal score can be the maximum of scores computed for the tags in the set of the tags. The tagger 102 next divides the scores of each tag in the set of tags by the maximal score, to produce normalized scores for the respective tags. The normalized scores can then be returned as scores for the tags, which can be output for selection at 316. Alternatively, the normalized scores can be compared to a specified threshold, and those tags from the set of tags having normalized scores that exceed the specified threshold are returned as tags for selection at 316. More generally, some other filtering function can be used to select a subset of tags returned by the tagger 102.

More formally, let D be a set of labeled program examples, where tags(d) denotes the set of tags of a program example d. Let sim(x, y) be the similarity function (e.g. a cosine document similarity function) that determines similarity between documents x and y (i.e. program code portion to be tagged and program example). The tagger 102 can be represented as a function label(x, k, c, D), where x is a program code portion to be tagged, k is the number of similar program examples from the examples index 104 to consider, c is a specified threshold, and D is the collection of program examples labelled with tags. The function label(x, k, c, D) returns a set of tags together with their scores, as follows.
1. Find the set N of k program examples in D with the highest similarity scores, as assigned by the similarity function sim(x, n.).
2. Let T=∪_{n∈N} tags(n), which is the union of tags of the set N of k program examples.
3. For all t∈T let

$$score ( t ) = {\sum }_{n ∈ N} \{ \begin{matrix}sim ( x , n ) & if t ∈ tags ( n ) \\ 0 & otherwise\end{matrix} .$$

4. Let m=max_{t∈T} score(t).
5. Return

$$\{ ( t , s ) \vert t ∈ T , s = score ( t ) , \frac{s}{m} \geq c \} .$$

Although specific techniques of assigning scores to tags for a given program tag portion to be tagged have been discussed above, it is noted that other techniques for assigning scores to tags can be used in other implementations. Also, in other implementations, other techniques for selecting tags output by the tagger 102 can be employed.

By using the tagger 102 according to some implementations, tagging of program code portions can be performed without having to design or train the tagger 102 for any specific programming language or technology. The tagger 102 can be made less complex and thus can execute more efficiently. The tagger 102 can also be flexibly used with any arbitrary portion of a program code, and can be used for various tags without having to design or train the tagger 102 for a predefined set of tags.

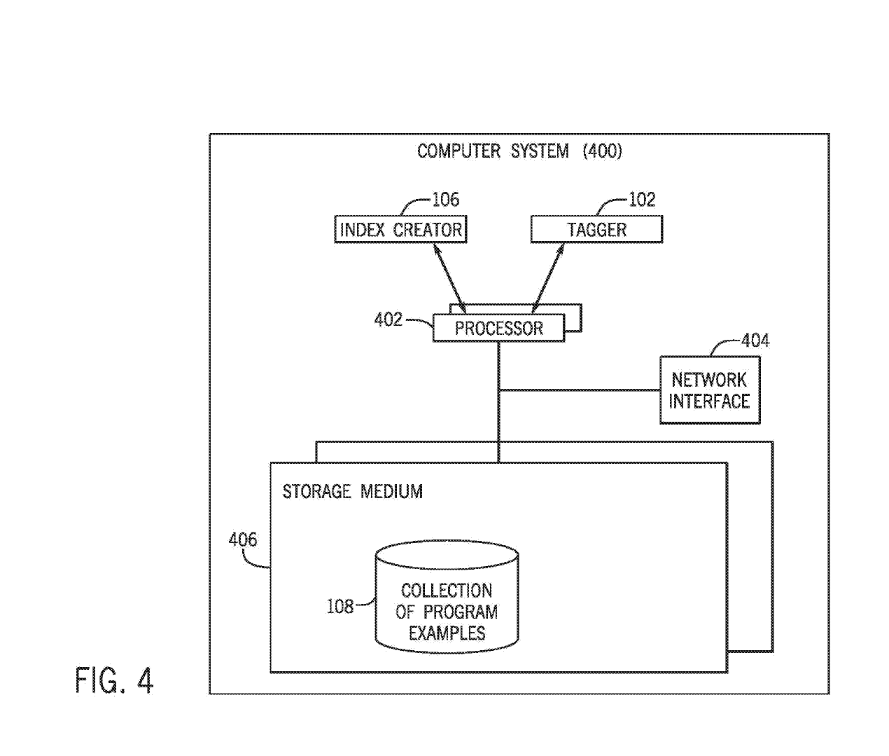

FIG. 4 is a block diagram of an example computer system 400, which can include one or multiple computers. The computer system 400 includes the index creator 106 and the tagger 102, which are executable on one or multiple processors 402. A processor can include a microprocessor, microcontroller, processor module or subsystem, programmable integrated circuit, programmable gate array, or another control or computing device. Note that the index creator 106 and the tagger 102 can be implemented on different computers, or can be implemented on the same computer.

The processor 402 can be coupled to a network interface 404 to allow the computer system 400 to communicate over a data network, Additionally, the processor(s) 402 can be coupled to a non-transitory computer-readable or machine-readable storage medium (or storage media) 406, which can store the collection of program examples 108 and other information, including instructions and data.

The storage medium or media 406 can include any of various different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method comprising:
receiving, by a system including a processor, a data structure created based on examples that include respective program code portions associated with corresponding tags that indicate content of the respective program code portions;
determining, by a tagger in the system, at least one tag to associate with a first program code portion based on the data structure;
receiving, by the system, an updated version of the data structure; and
determining, by the tagger that remains unmodified after receiving the updated version of the data structure, at least one tag to associate with a second program code portion based on the updated version of the data structure.

2. The method of claim 1, wherein the tagger is to use the updated version of the data structure to tag the second program code portion for a different programming language, a different programming technology, or an additional tag, without modification of the tagger.

3. The method of claim 1, further comprising:
parsing the first program code portion;
extracting text elements from the first program code portion according to the parsing,
wherein determining the at least one tag to associate with the first program code portion uses the extracted text elements.

4. The method of claim 3, wherein the parsing comprises removing non-text elements of the first program code portion.

5. The method of claim 3, wherein the parsing comprises rewriting one or multiple of the text elements into a set of tokens, wherein determining the at least one tag compares the set of tokens to respective elements of the program code portions in the examples.

6. The method of claim 3, wherein the parsing is performed without assuming any specific programming language of the first program code portion.

7. The method of claim 1, wherein determining the at least one tag to associate with the first program code portion comprises:
computing scores for a plurality of tags based on comparing elements from the first source code portion to elements of the examples of data structure; and
selecting the at least one tag to associate with the first program code portion based on the computed scores.

8. The method of claim 7, wherein comparing the elements comprises:
determining similarity of the elements of the received source code portion to the elements of the examples of the data structure.

9. The method of claim 1, further comprising:
generating the updated data structure for at least one of a new programming language, a new programming technology, and a new tag.

10. A system comprising:
a storage medium to store an index that correlates examples including program code portions with corresponding tags that indicate content of respective program code portions, the index useable to identify tags for program code portions that are to be tagged;
at least one processor; and
a tagger executable on the at least one processor to:
receive an updated version of the index that relates to a different collection of examples including program code portions with corresponding tags that indicate content of respective program code portions;
compare, without modifying the tagger, content of a first program code portion with content of examples including program code portions in the updated version of the index;
identify, for the first program code portion, at least one tag from the updated version of the index based on the comparing.

11. The computer system of claim 10, wherein the tags are selected from among information identifying a programming language, information identifying a programming technology, information identifying a topic, and information identifying a skill.

12. The computer system of claim 10, wherein the updated version of the index includes further examples including program code portions for at least one of a new programming language, a new programming technology, and a new tag, the further examples not previously included in the index stored in the storage medium.

13. The computer system of claim 10, wherein index includes entries that each includes a set of tokens parsed from an example including a program code portion, and information relating to one or more tags associated with the set of tokens.

14. The computer system of claim 10, wherein the tagger is executable to parse the first program code portion without assuming any specific programming language for the first program code portion.

15. An article comprising at least non-transitory one machine-readable storage medium storing instructions that upon execution cause a computer system to:
receive a first version of a data structure created based on examples that include respective program code portions associated with corresponding tags that indicate content of the respective program code portions;
determine, by a tagger, at least one tag to associate with a first program code portion based on the data structure;
receive an updated version of the data structure that contains a further example for a new programming language, anew programming technology, or a new tag not represented by the first version of the data structure; and
determine, by the tagger that remains unmodified after receiving the updated version of the data structure, at least one tag to associate with a second program code portion based on the updated version of the data structure.
